(19) United States
(12) Patent Application Publication
(10) Pub. No.: US 2007/0106606 A1
(43) Pub. Date: May 10, 2007

(54) Near Real Time Payment Card Processing with On-Line Authorization on a Vehicle

(75) Inventors: Darin R. Pankratz, Bothell, WA (US); Donald J. Ferrel, Bellevue, WA (US); Tim V. Rider, Alpharetta, GA (US)

Correspondence Address: LEE & HAYES, PLLC, 421 W. RIVERSIDE AVE., SUITE 500, SPOKANE, WA, 99201, US

(73) Assignee: The Boeing Company, Chicago, IL (US)

(21) Appl. No.: 11/552,114

(22) Filed: Oct. 23, 2006

Related U.S. Application Data
(60) Provisional application No. 60/730,109, filed on Oct. 24, 2005.

(51) Int. Cl. G06Q 40/00

(52) U.S. Cl. 705/40

(57) ABSTRACT

Systems and methods for near real time payment processing on a vehicle are disclosed. In one embodiment, the method includes logging in at least one operator to conduct one or more transactions on a payment transaction system, and then automatically propagating at least one piece of itinerary information into each transaction. The method continues when an operator selects at least one commodity for purchase from a software database of commodities for each transaction. When at least one commodity is selected for each transaction, the operator then requests a card payment online authorization from a ground transaction processor. Once one of a payment approval or payment card denial is received in near real time, the method respectively completes the purchase on the payment transaction system or terminates the purchase. In an additional embodiment, a transaction summary is sent to at least one of an interested third party and a carrier owner.

### CROSS REFERENCE TO RELATED APPLICATIONS

This patent application claims priority from commonly-owned U.S. Provisional Application No. 60/730,109 entitled “Near Real Time Payment Card Processing With On-Line Authorization On A Vehicle” filed on Oct. 24, 2005, which provisional application is incorporated herein by reference.

### FIELD OF THE INVENTION

This invention relates to systems and methods for payment process, and more specifically, to systems and methods for processing payment cards in near real time on vehicles.

### BACKGROUND OF THE INVENTION

Airlines conduct the sales of beverages, duty-free items, and in-flight entertainment to passengers during commercial flights. Passengers may pay for such sale by using either cash or credit cards. In general, systems provided for accepting payments by credit cards require such payments be temporarily recorded and then batch processed on the ground at a later date.

Although desirable results have been achieved using such prior art systems, there may be room for improvement. For example, the fact that credit card payments made on commercial flights must be batch processed on the ground at a later date makes the detection of unauthorized credit card use difficult. Furthermore, the recording of credit card payments in the air for batch processing of transactions on the ground may produce additional administrative time and cost, additional staff burden and workload on the ground as well as in the air. Therefore, novel systems and methods which mitigate these undesirable characteristics would therefore be highly desirable.

### SUMMARY OF THE INVENTION

The present invention is directed to systems and methods for processing payment cards in near real time on vehicles. Embodiments of systems and methods in accordance with the present invention may advantageously reduce the administrative time and cost associated with payment handing and processing, and may reduce incidents of unauthorized credit card use, in comparison with the prior art.

In one embodiment, the method for conducting a near real-time payment card processing on a vehicle includes logging in at least one operator to conduct one or more transactions on a payment transaction system, and then automatically propagates at least one piece of itinerary information into each transaction. The method continues when an operator selects at least one item for purchase from a software database of commodities for a transaction. When at least one item is selected for the transaction, the operator then requests a first card payment online authorization from a ground transaction processor of the payment transaction system. Once one of a payment approval or payment card denial is received in near real time, the method either completes the purchase on the payment transaction system or terminates the purchase. In a particular embodiment, the method further includes displaying one of a payment approval or payment card denial to at least one operator after a transaction is complete. In an alternate embodiment, the method also includes at least one of obtaining a signature from a payment card holder and printing a receipt when payment approval is received for each transaction. In another embodiment, automatically propagating at least one piece of itinerary information into each transaction includes propagating at least one of a flight number, a flight origin, and a flight destination. In an additional embodiment, the method further includes sending at least one transaction summary to at least one of a vehicle operator and a third party, wherein the transaction summary is at least based on the aggregated commodities purchased, quantities of each commodity purchased, the monetary value of the purchases, and the transaction numbers of the purchases.

### BRIEF DESCRIPTION OF THE DRAWINGS

Embodiments of the present invention are described in detail below with reference to the following drawings.

FIG. 1 is a schematic representation of the four main conceptual components of a near real time payment processing system, in accordance with an embodiment of the invention;

FIG. 2 is a schematic representation of the architectural concepts of a first near real time payment processing system in accordance with an embodiment of the invention;

FIG. 3 is a schematic representation of the architectural concepts of a second near real time payment processing system in accordance with an embodiment of the invention;

FIG. 4 is a flowchart showing a method of performing a near real time card payment transaction in accordance with an embodiment of the invention;

FIG. 5 is a flowchart showing a method of performing a near real time cash payment transaction in accordance with an embodiment of the invention; and

FIG. 6 is a side elevational view of an aircraft in accordance with another embodiment of the invention.

### DETAILED DESCRIPTION

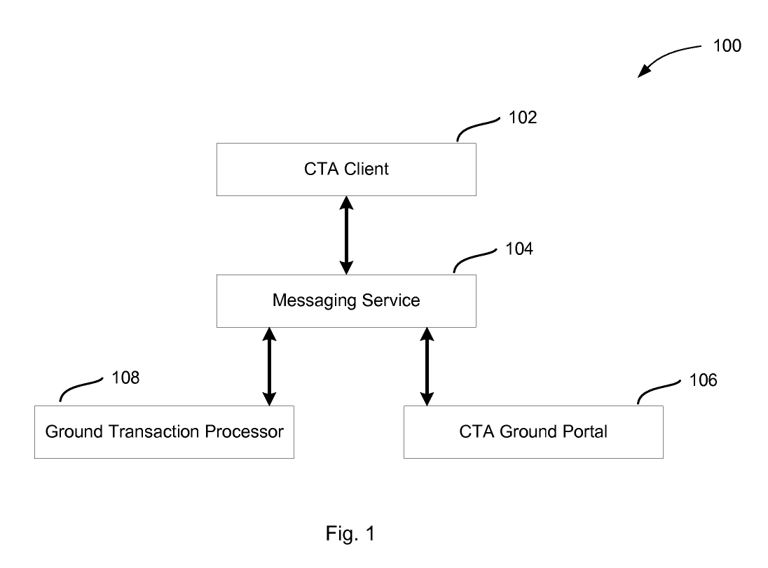

The present invention relates to systems and methods for payment processing, processing payment cards in near real time on aircraft and the like. Many specific details of certain embodiments of the invention are set forth in the following description and in FIGS. 1-6 to provide a thorough understanding of such embodiments. The present invention may have additional embodiments, or may be practiced without one or more of the details described below.

Generally, embodiments of systems and methods in accordance with the present invention provide system for processing credit card payments in near real time on vehicles. In the case of an aircraft, embodiments of the invention advantageously allow the acceptance or denial of passenger credit card payments by the cabin crew, as the credit card payments are authorized or declined in near real time. Thus, embodiments of the invention may advantageously detect and reduce unauthorized credit card use, eliminate the administrative cost and burden associated with temporary recordation and then batch processing of card payments, in comparison with the prior art systems and methods.

FIG. 1 is a schematic representation of the main conceptual subsystems of a near real time payment processing network, in accordance with an embodiment of the invention. In this embodiment, the network includes an air client component 102, a messaging service component 104, a cabin transaction application (CTA) ground portal component 106, and a ground transaction processor 108. The air client component 102 may include a Point of Sale device, embedded pricing menu, and applications and tools to capture credit card transactions, cash transactions, electronic signature for distribution to other components of the processing network, as well applications and tools that provide printer functionality. The messaging service component 104 provides transfer of the data capture by air client component 102 to the CTA ground portal 106 and the ground transaction processor 108 over a data network.

In one embodiment, the messaging service component 104 includes data transport services (DTS) functions that guarantee transfers, and provide notification of data service provider (DSP) availability for queued transactions. The ground portal 106 may provide a database of all transactions for a given airline, and may provide summaries of data by flight, date, and aircraft. In a particular embodiment, the data may be searchable down to individual transactions. In another embodiment, the ground portal 106 may allow direct menu or pricing administration from the ground. It will be appreciated that there may be more than one ground portal, if isolation of an airline is desired for purposes such as security. Finally, the ground transaction processor 108 provides credit card approvals and denials that are distributed back to the air client component 102 via the messaging service 104.

The near real time processing network, as illustrated in FIG. 1, may be implemented using the Boeing Core Network Applications System (CNAS). CNAS is one part of Boeing's overall e-Enabled Airplane Architecture. While CNAS does not interact with or support flight-essential functions of an aircraft, it operates in near-real time to store, forward, and transport data between an aircraft and a ground network. CNAS comprises both airborne and ground segments. The airborne segment includes the aircraft resident host hardware system and software applications, peripherals and their software that form part of the system, as well as the interfaces to other aircraft systems and users. The ground segment provides the necessary processing and storage required to support the applications and to provide bidirectional data routing between the CNAS and such external systems as airline systems and credit card processing centers. CNAS may be used by any application that requires near real time information processing, data storage, or communication between an aircraft and a ground network.

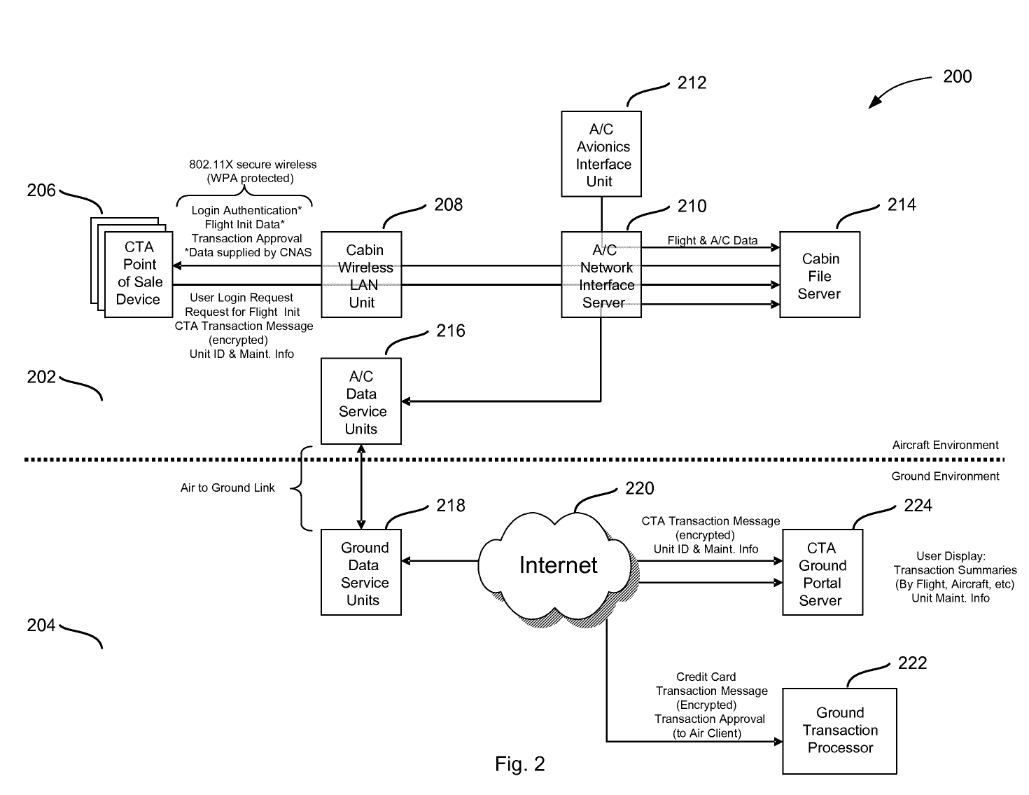

FIG. 2 is a schematic representation of the network architecture of a first near real time payment processing system in accordance with an embodiment of the invention. In this embodiment, the system includes an Aircraft Environment 202, and a Ground Environment 204. The aircraft environment 202 includes a cabin transaction application (CTA) Point of Sale Device 206. The Device 206 is a dedicated hand-held “thick client” that hosts the CTA functionalities (e.g., store and display items to be purchased, transmit payment card information for purchase transactions, and receive approvals and denials of card payment for each transaction, etc.). The Device 206 is bi-directionally and operatively linked to a Cabin File Server 214 through a Cabin Wireless LAN Unit 208 and an Aircraft Network Interface Server 210. The link between the device 206 and Cabin Wireless LAN Unit 208 is a secure wireless connection. In one embodiment, it may be an 802.11X WPA protected connection. The secure wireless connection allows the wireless transport of data, such as user login requests, requests for flight initialization information, identification and maintenance information, as well as encrypted CTA transaction messages, from the device 206 to the Cabin File Server 214 via the Cabin Wireless LAN Unit 208. The secure wireless connection also allows the transport of data, such as login authentication, flight initialization data, credit card transaction approval or denial, and other data, from the Cabin File Server 214 to the Device 206 via the Cabin Wireless LAN Unit 208. In a particular embodiment, the flight initialization data may include aircraft identification information, flight number, city pair, as well as other relevant flight information. It will be appreciated that the Cabin File Server 214 includes hardware and software applications that operates in near real time to bi-directionally store, forward and transport data between Aircraft Environment 202 and Ground Environment 204 over a network. In other embodiments, the Cabin File Server 214 is further equipped with software applications that authenticates users based on user logins, as well as software applications that automatically provide flight initialization data to the one or more CTA Point of Sale Devices 206.

As further illustrated in FIG. 2, the Aircraft Network Interface Server 110 operatively links the Aircraft Avionics Interface Unit 212 to the Cabin File Server 214. More significantly, the Aircraft Network Interface Server 210 also bi-directionally and operatively links the Cabin File Server 214 with to one or more Aircraft Data Service Unit 216. The Aircraft Data Services Units 216, in conjunction with one or more Ground Data Service Units 218, allows the exchange of data between the Aircraft Environment 202 and the Ground Environment 204. It will be appreciated that the air-and-ground data service architecture of the Aircraft Data Service Units 216 and Ground Data Service Units 218, as well the components of the units 216 and 218, are dependent on the service providers and/or technology employed. The type and components of the air-and-ground link between units 216 and 218 are also determined by the data service selected. For example, the link may be based on satellite, ground based wireless, or other appropriate technology. The Ground Data Service Units 218, in turn, is bi-directionally and operatively linked with a CTA Ground Portal Server 222 via an Internet backbone 220. It will be further appreciated that in this particular embodiment, the data from the aircraft is routed from the Cabin file server 214 directly to the CTA Ground Portal server 222 via the Internet backbone 220, and vice versa.

With continued reference to FIG. 2, the Internet backbone 220 also bi-directionally and operatively links a CTA Ground Portal Server 222 to a Ground Transaction Processor 224. The CTA Ground Portal Server 222 receives relevant data, including encrypted CTA transactions message, as well as CTA Point of Sale device 206 Unit ID and maintenance information, via the Internet backbone 220. As further illustrated in FIG. 2, the Ground Transaction Processor 224 receives encrypted payment card transactions messages from the CTA Ground Portal Server 222, and sends payment card approvals and denials to the CTA Ground Portal Server 222, which in turn relays them through the system to the CTA Point of Sale Device 206. In one embodiment, the CTA Point of Sale Device 206 is configured to provide transaction information of each transaction approved by the Ground Transaction Processor 224 to the Cabin File Server 214. This transaction information includes items and quantities purchased, amount of purchase, and a transaction tracking number. The Cabin File Server 214, in turn, is further configured to supply flight close-out messages and transactions summaries based on the aggregated transaction information. In this embodiment, the CTA Ground Portal Server 222 is equipped to provide transaction summaries to appropriate parties (e.g., airlines, suppliers, auditors, etc.) It will be appreciated that the transaction summaries contains aggregated information that may include items purchased, quantities purchased, monetary amounts of purchase, transaction tracking numbers, flight numbers, aircraft numbers, city pairs and passenger data. Moreover, transaction summaries may be organized by flight data, aircraft information, etc. In an additional embodiment, the CTA Ground Portal server 222 is also equipped to pass on the Unit ID and maintenance information of CTA Point of Sale Device 206 to the appropriate parties.

In a further embodiment of the near real time processing system of FIG. 2, the CTA Point of Sale Device 206 is equipped with a printer and related CTA functionalities for printing receipts, and with an input mechanism and related CTA functionalities to accept electronic signatures. It will be appreciated that the embodiment of the near real time processing system, as shown in FIG. 2, allows near instantaneous validation of credit card payments through the system.

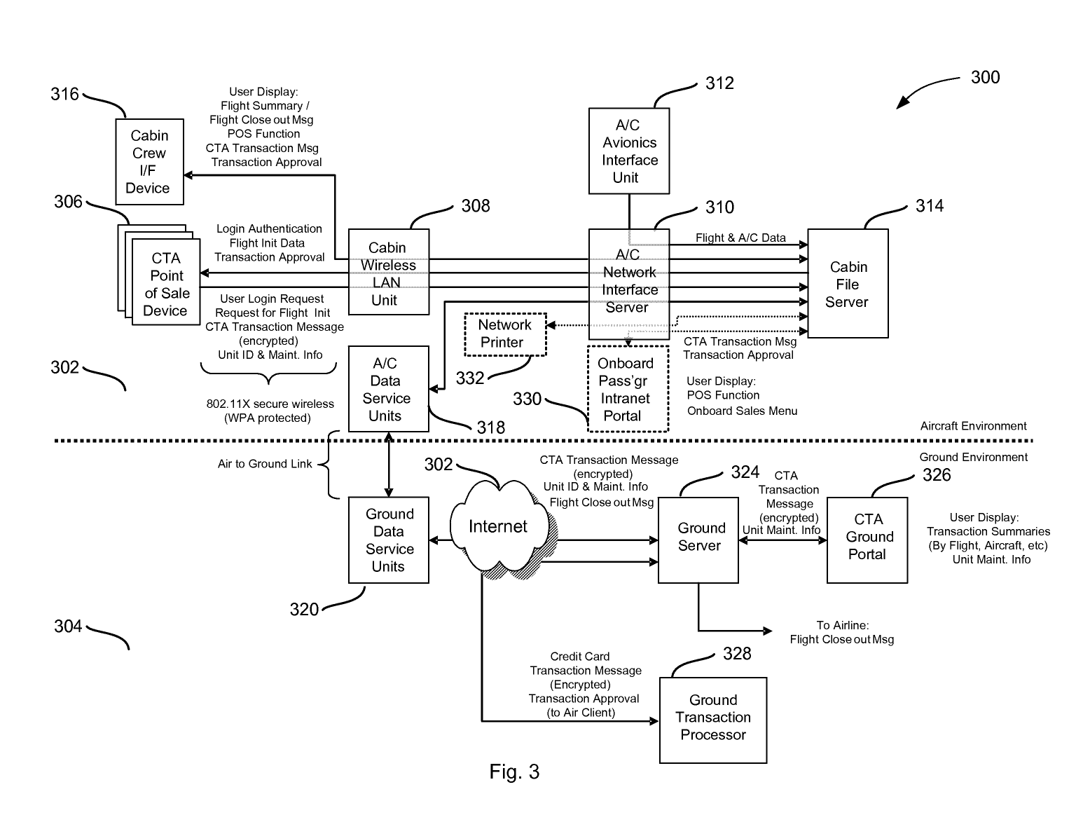

FIG. 3 is a schematic representation of the network architecture of a second near real time payment processing system in accordance with an embodiment of the invention. In this embodiment, the system includes an Aircraft Environment 302, and a Ground Environment 304. The aircraft environment 302 includes a CTA Point of Sale device 306. The device 306 is a dedicated hand-held “thick client” that hosts the CTA functionalities (e.g., store and display items to be purchased, transmit payment card information for transactions, and receive approvals and denials of the card payment for each transaction, etc.). However, in another embodiment, the CTA Point of Sale device 406 is a hand-held “thin client”, and the associated applications are hosted on the Cabin File Server 414. The device 306 may be bi-directionally and operatively linked to the Cabin File Server 314 through a Cabin Wireless LAN Unit 108 and an Aircraft Network Interface Server 310. The link between the device 306 and Cabin Wireless LAN Unit 108 is a secure wireless connection. In one embodiment, it may be an 802.11X WPA protected connection. The secure wireless connection allows the wireless transport of data, such as user login requests, requests for flight initialization information, identification and maintenance information, as well as encrypted CTA transaction messages, from the Device 306 to the Cabin File Server 314 via the Cabin Wireless LAN Unit 308. The secure wireless connection also allows the transport of data, such as login authentication, flight initialization data, credit card transaction approval, and other data from the Cabin File Server 314 to the Device 306 via the Cabin Wireless LAN Unit 308. In a particular embodiment, the flight initialization data may include aircraft identification information, flight number, city pair, as well as other relevant flight information.

It will be appreciated that the Cabin File Server 314 includes hardware and software applications that operates in near real time to bi-directionally store, forward and transport data between Aircraft Environment 302 and Ground Environment 304 over a network. In one embodiment, the Cabin File Server 314 is further equipped with software applications that authenticates users based on user logins, as well as software applications that automatically provide flight initialization data to one or more CTA Point of Sale Devices 306.

As further illustrated in FIG. 3, the aircraft environment 302 further includes a Cabin Crew Interface Device 316 that is bi-directionally and operatively linked with the Cabin File Server 314 through the Cabin Wireless LAN Unit 308 and the Aircraft Network Interface Server 310. The link between the Cabin Crew Interface Device 216 and the Cabin Wireless LAN Unit 308 is also a secure wireless connection. The secure wireless connection allows the Cabin File Server 314 to provide the Cabin Crew Interface Device 316 with useful information, such as flight transaction summaries and flight close-out messages.

With continued reference to FIG. 3, the Aircraft Network Interface Server 310 also operatively links the Aircraft Avionics Interface Unit 312 to the Cabin File Server 314. More significantly, the Aircraft Network Interface Server 310 also bi-directionally and operatively links the Cabin file Server 314 with to one or more Aircraft Data Service Unit 318. The Aircraft Data Service Units 318, in conjunction with one or more Ground Data Service Units 320, allows the exchange of data between the Aircraft Environment 202 and the Ground Environment 304. It will be appreciated that the air-and-ground data service architecture of the Aircraft Data Service Units 318 and Ground Data Service Units 220, as well the components of the units 318 and 320, are dependent on the service providers and/or technology employed. Moreover, it will also be appreciated that the type and components of the air-and-ground link between units 318 and 320 are determined by the data service selected. For example, the link may be based on satellite, ground based wireless, or other appropriate technology.

The Ground Data Service Units 320, in turn, is bi-directionally and operatively linked with a Ground Server 324 via an Internet backbone 322. It will be appreciated that the ground server 324 includes hardware and software applications that provides the necessary processing and storage required to bi-directionally communicate with the Cabin File Server 314, and to provide bi-directional data routing to external ground systems. The Ground Server 324 receives relevant data, including encrypted CTA transactions message, Point of Sale Device Unit ID and maintenance information, as well as flight close-out messages, via the Internet backbone 322.

In one particular embodiment, the Cabin File Server 314 and the Ground Server 324 may be respectively provide with a Data Transfer Service (DTS) air segment, and a DTS ground segment, that routes the data from the Air Environment 302 to the Ground Environment 304, and vice versa. The Data Transport Service (DTS) handles the transfer of data between the airborne and ground segments. It is a service that addresses all of the needs while hiding the details of links management and data transfers. DTS are provided on the basis of type of service needed, such as immediate transfer, store and forward, a well as validation. The DTS matches the type of service required to the transport mechanisms available (e.g., Connexion® by Boeing, Airfone, or GateLink). The DTS has the ability to guarantee messaging.

Moreover, the Ground Server 324 is further bi-directionally and operatively linked with Ground Transaction Processor 328. As illustrated in FIG. 3, the Ground Transaction Processor 328 receives encrypted credit card transactions messages from the Ground Server 324, and sends transactions approvals and denials to the Ground Server 324, which in turn sends them through the network to the CTA Point of Sale Device 306. In one embodiment, the CTA Point of Sale Device 306 is configured to provide transaction information for each transaction approved by the Ground Transaction Processor 328 to the Cabin File Server 314. This transaction information includes items and quantities purchased, amount of purchase, and a transaction tracking number. The Cabin File Server 314, in turn, is further configured to supply flight close-out messages and transactions summaries based on the aggregated transaction information. It will be appreciated that flight close-out messages contain transaction summaries, and that both flight close-out messages and transaction summaries contains aggregated information that may include items purchased, quantities purchased, monetary amounts of purchases, transaction tracking numbers, flight numbers, aircraft numbers, city pairs and passenger information.

As further shown in FIG. 3, the Ground Server 324 is bi-directionally and operatively linked to a CTA Ground Portal 326. The Ground Server 324 exchanges encrypted CTA transactions message, as well as device unit maintenance information, with CTA Ground Portal 326. In turn, the CTA Ground Portal Server 326 is equipped to provide transaction summaries to third parties (e.g., airlines, suppliers, auditors, etc.) Moreover, transaction summaries may be organized by flight data, aircraft information, etc. In an additional embodiment, the CTA Ground Portal server 222 is also equipped to pass on the Unit ID and maintenance information of CTA Point of Sale Device 306 to the appropriate parties. Finally, the Ground Server 324 also provides flight close-out messages to the airlines.

In another embodiment of the near real time processing system illustrated in FIG. 3, the Cabin File Server 314 also includes one or more software applications that provides additional data, such as cash sum and reconciliation, total sale by item (basic inventory depletion amounts), and payment type. This data may be accessed via the Crew Interface Device 316. In additional embodiments, this data may also be captured in transaction messages and sent to the airlines using Ground Server 326.

In a further embodiment of the near real time processing system illustrated in FIG. 3, the Cabin File Server 314 may host software applications that provide a “Point of Sale function” and on-board passenger web “intranet” portals 330. The on-board passenger intranet web portals 330 use the “Point of Sale” function to displays sale menus and enable “online” purchases. These purchases are processed in near real time in the same way as regular CTA transactions. In this embodiment, the Cabin File Server 314 may further host software applications that support a network printer 332, for the purpose of printing receipts from the “portal” sales. In another embodiment, the “Point of Sale” function is also accessible from the Cabin Crew Interface Device 316.

In an additional embodiment of the near real time processing system of FIG. 3, the CTA Point of Sale Device 306 is equipped with a printer and related CTA functionalities for printing receipts, and with an input mechanism and related CTA functionalities to accept electronic signatures. Finally, it will be appreciated that the embodiments of the near real time processing system, as shown in FIG. 3, allows near instantaneous validation of payment card transactions (e.g., credit, debit, pre-paid, airline credit) through the network, as well as cash transactions.

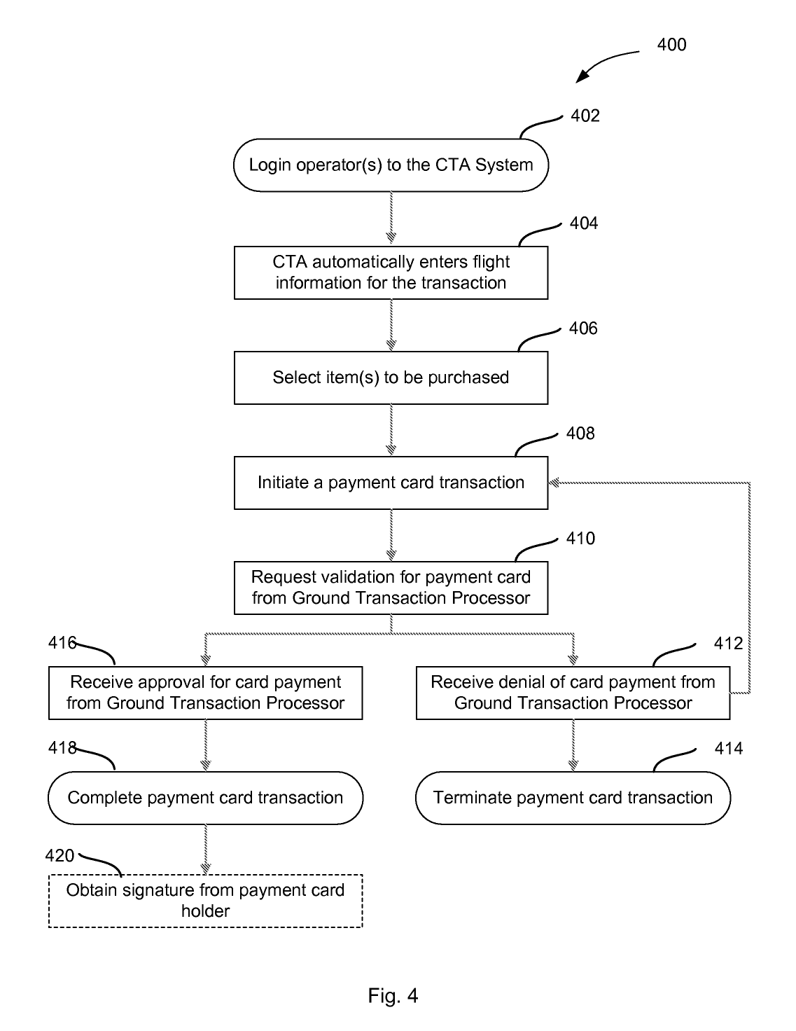

FIG. 4 is a flowchart showing a method of performing a near real time card payment transaction, using at least one embodiment of a near real time payment system, in accordance with an embodiment of the invention. The method starts at block 402, where the one or more operators login to a CNAS system via a CTA hand-held device, also known as a CTA Point of Sale Device. In one embodiment, the CTA hand-held device is a “thick client”, while in another embodiment, the CTA hand-held device is a “thin client”. The operators may include a designated pursuer and/or members of the cabin crew.

Once login is complete, the method proceeds to block 404, at which point the payment processing system automatically enters flight information. In one embodiment, the flight information may include the date, aircraft number, city pair, airline ID, transaction tracking, flight attendant name, and corporate ID. It will be appreciated that the system may not display the above flight information to the operators. Instead, the system may simply associate the CTA transaction with the information. Once the flight information has been automatically entered, the operators may begin process sales transactions by selecting one or more items to be purchased at block 406. In one embodiment, the operator may make a selection from multiple icons on the home screen of the CTA hand-held device. For example, the CTA home screen may include icons for BEVERAGE, MEALS, DUTY FREE, SNACKS, UPGRADES, SERVICES, CHECKOUT, FLIGHT CLOSEOUT, or any other suitable icon types. In another embodiment, the icons on the home screen may activate one or more drop down lists that allow the operator to select specific items. For example, the MEALS icon may produce a drop down list for various available items (e.g. TURKEY CLUB, CHEF SALAD, BAGEL, CREAM CHEESE, etc).

Once the operator has made a selection and the quantity, the operator returns to the home screen where the selection and price are displayed in a list of purchased items below the icons. Upon confirming the request for the one or more items, the operator proceeds to block 408 and initiates a payment card transaction. In the embodiments discussed above, the operator may proceed to block 410 by selecting CHECKOUT, which may cause a screen to display the total purchase amount and multiple icons. The icons may include CASH, CREDIT CARD, DEBIT CARD, MILES CARD, as forms of payment. Once the operator receives a payment card and selects the appropriate type from the icons, the operator may swipe the payment card in an attached card reader to initiation a payment card transaction.

The swiped payment card information, including credit card number and transaction tracking number, are sent to a ground transaction processor (credit card clearing house) for online authorization at block 410. If the card payment is approved at block 416, the online authorization is routed back to an application onboard the aircraft in near real time. It will be appreciated that obtaining an online authorization is a process whereby a ground transaction processor approvals or denials a card payment request prior to the completion of a sale transaction. Exemplary online authorizations are those currently implemented by Visa® for credit card transactions. In one embodiment, the online authorization process typically takes less than 5 seconds. However, in other embodiments, the online authorization process may take as much time as a ground transaction processor needs to process an online authorization in what the ground transaction processor typically considers in real time.

At block 420, the application notes in its transaction log that the credit card transaction was authorized and changes the transaction status to “complete”. An application then causes the hand-held device to display windows or icons stating that the items purchased are paid. In a particular embodiment, the operator may use the hand-held device to print a receipt for the purchased items. In another embodiment, once the transaction is complete at block 418, the operator may elect to obtain a signature from the payment card holder at block 420.

Returning to block 414, if the card payment is denied following a card swipe at block 410, the denial is routed back to an application onboard the aircraft. In a particular embodiment, an application then causes the hand-held device to display a flashing window including one of a rejection message, and at least one of the payment card holder's name, the transaction tracking number, the amount of the purchase, items purchased, and a question as to whether or not to reprocess the transaction with another form of payment. If reprocessing of the card payment is desired, then method may return to block 408. However, if no reprocessing of the card payment is needed, the operator terminates the transaction at block 414. In an embodiment, the operator terminates the transaction by entering “NO” in response to the message on the hand-held device, and an application records the failed transaction.

In further embodiments, once the transaction is complete at block 418, transactions information, including items purchased, amount of purchase, transaction tracking number, flight number, aircraft number, city pair and passenger information may be sent to an appropriate third party or an appropriate airline. Nevertheless, it will be appreciated that in other embodiments, such information may be sent prior to the completion of the transaction at block 420 or termination of the transaction at block 414. Moreover, it will be further appreciated that an airline may use this information to reconcile payments from the clearing house and paper receipts from the flight, track inventory and aircraft provisioning, and manage customer relations.

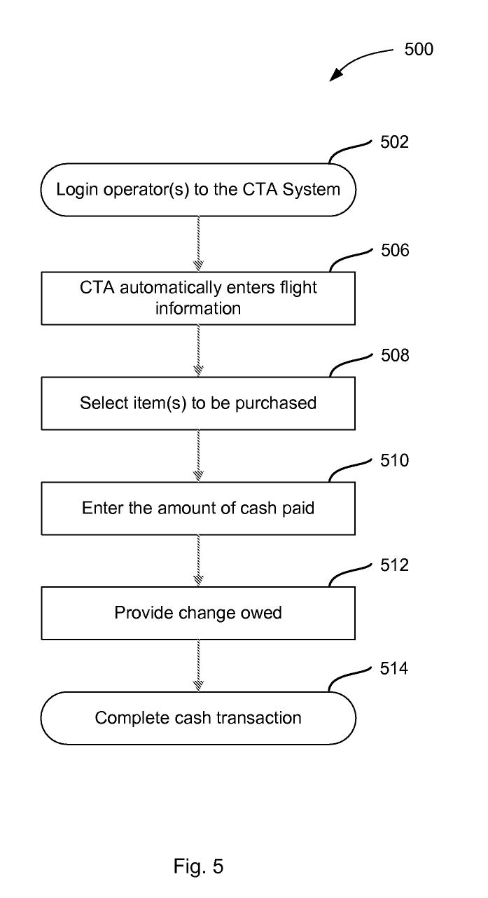

FIG. 5 is a flowchart showing a method of performing a near real time cash payment transaction, using at least one embodiment of a near real time payment system, in accordance with an embodiment of the invention. The method starts at block 502, where the one or more operators login to a payment processing system via a CTA hand-held device. In one embodiment, the CTA hand-held device is a “thick client”, while in another embodiment, the CTA hand-held device is a “thin client”. The operators may include a designated pursuer and/or members of the cabin crew. Once login is complete, the method then proceeds to block 504, at which point the payment processing system automatically enters flight information. In one embodiment, the flight information may include the date, aircraft number, city pair, airline ID, transaction tracking, flight attendant name, and corporate ID. It will be appreciated that the system may not display the above flight information to the operators. Instead, the system may simply associate the CTA transaction with the information. Once the flight information has been automatically entered, the operators may begin process sales transactions by selecting one or more items to be purchased at block 506. In one embodiment, the operator may make a selection from multiple icons on the home screen of the CTA hand-held device. For example, the CTA home screen may include icons for BEVERAGE, MEALS, DUTY FREE, SNACKS, UPGRADES, SERVICES, HEADSET, CHECKOUT, and FLIGHT CLOSEOUT or any other suitable icon types. In another embodiment, the icons on the home screen may activate one or more drop down lists that allow the operator to select more specific items.

When the operator has made a selection and the quantity using the icons (e.g., HEADSET), the operator returns to the home screen where the selection and price are displayed in a list of purchased items below the icons. Upon verbally confirming the request for the one or more items, the operator proceeds to block 508 by selecting CHECKOUT, which may cause a screen to display the total purchase amount and multiple icons. The icons may include CASH, CREDIT CARD, DEBIT CARD, MILES CARD, or other suitable icons, as forms of payment. Once the operator asks and receives cash as payment, the operator selects the CASH, which generates another screen on the hand-held device. This screen contains a field for entering the amount of cash received from the passenger and a PAID icon. After the operator enters the amount and selects PAID, the method proceeds to block 510. An application calculates the amount of change owed, if any, at block 510. In one embodiment, the PAID icon changes shading to indicate that it can no longer be accessed at block 510. The operator then provides the correct change to the payee. Finally, the method proceeds to block 512, where the application creates a transaction log item that includes the transaction tracking number, transaction amount, method of payment, and notes that its payment status is “Complete.”

In further embodiments, once the transaction is complete at block 512, transactions information, including items purchased, amount of purchase, transaction tracking number, flight number, aircraft number, city pair and passenger information may be sent to an appropriate third party or an appropriate airline. Moreover, it will be appreciated that an airline may use this information to reconcile payments from the clearing house and paper receipts from the flight, track inventory and aircraft provisioning, and manage customer relations.

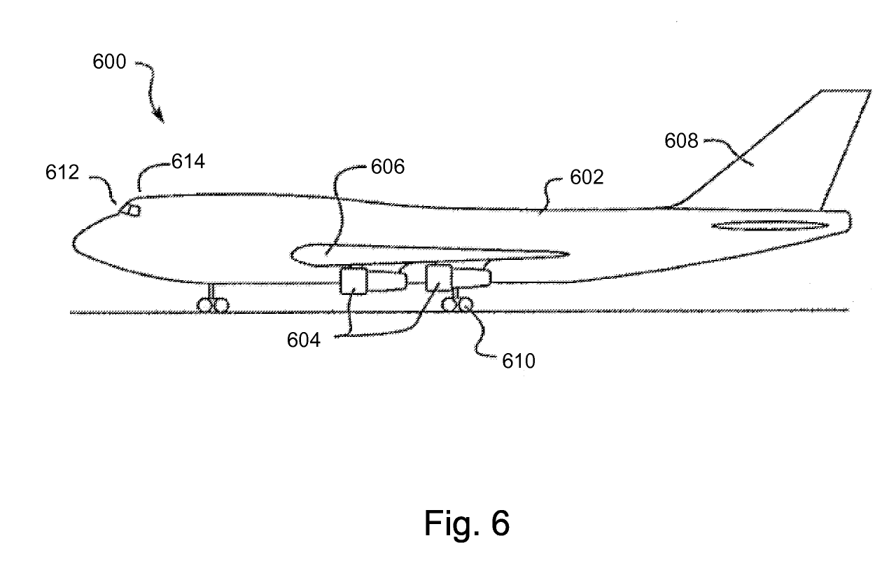

Embodiments of the present invention may be used in a wide variety of vehicles, including aircraft, ships, trains, and any other suitable vehicle. For example, FIG. 6 is a side elevational view of an aircraft 600 in accordance with an embodiment of the present invention. In general, except for one or more systems in accordance with the present invention, the various components and subsystems of the aircraft 600 may be of known construction and, for the sake of brevity, will not be described in detail herein. As shown in FIG. 6, the aircraft 600 includes one or more propulsion units 604 coupled to a fuselage 602, a cockpit 612 in the fuselage 602, wing assemblies 606 (or other lifting surfaces), a tail assembly 608, a landing assembly 610, a control system (not visible), and a host of other systems and subsystems that enable proper operation of the aircraft 600. At least one component of the near real time payment system 614 formed in accordance with the present invention is located within the fuselage 602. However, components of the system 614 may be distributed throughout the various portions of the aircraft 600.

Although the aircraft 600 shown in FIG. 6 is generally representative of a commercial passenger aircraft, including, for example, the 737, 747, 757, 767, 777, and 787 models commercially-available from The Boeing Company of Chicago, Ill., the inventive apparatus and methods disclosed herein may also be employed in the assembly of virtually any other types of aircraft. More specifically, the teachings of the present invention may be applied to the manufacture and assembly of other passenger aircraft, cargo aircraft, rotary aircraft, and any other types of aircraft, including those described, for example, in The Illustrated Encyclopedia of Military Aircraft by Enzo Angelucci, published by Book Sales Publishers, September 2001, and in Jane's All the World's Aircraft published by Jane's Information Group of Coulsdon, Surrey, United Kingdom, which texts are incorporated herein by reference. It may also be appreciated that alternate embodiments of system and methods in accordance with the present invention may be utilized in other manned aerial vehicles.

Embodiments of systems and methods in accordance with the present invention may provide significant advantages over the prior art. For example, because the near real time payment system provides near instantaneous authorization or denial of card payments, the system may reduce incidents of unauthorized credit care use. Furthermore, the near real time payment system for processing payment card transactions may also reduce the administrative time and cost associated with payment handing and processing, both on the ground and in the air, and may reduce revenue shrinkage due to paperwork loss or error.

While embodiments of the invention have been illustrated and described above, many changes can be made without departing from the spirit and scope of the invention. Accordingly, the scope of the invention is not limited by the disclosure of these embodiments. Instead, the invention should be determined entirely by reference to the claims that follow.

What is claimed is:

1. A method for conducting a near real-time payment card processing on a vehicle, comprising:
selecting at least one commodity for purchase from a menu of commodities for each of the one or more transactions;
requesting an online authorization from a ground transaction processor of a payment transaction system for each of the one or more transactions; and
receiving one of a payment approval that completes the purchase on the payment transaction system and a payment card denial that terminates the purchase for each of the one or more transactions, wherein the payment card approval and the payment card denial are received in near real time from the ground transaction processor.

2. The method of claim 1, further comprising, prior to selecting at least one commodity for purchase, logging in at least one operator to conduct one or more transactions on a payment transaction system, and propagating at least one piece of itinerary information into each of the one or more transactions by automatic entry.

3. The method of claim 1, further comprising displaying one of a payment approval or payment card denial to the at least one operator for each of the one or more transactions.

4. The method of claim 1, wherein propagating at least one piece of itinerary information into each of the one or more transactions by automatic entry includes propagating at least one of a flight number, a flight origin, and a flight destination into each of the one or more transactions.

5. The method of claim 1, further comprising recording a transaction entry for each of the one or more transactions, wherein each cash transaction entry includes at least one of commodities purchased, a quantity of each commodity purchased, a monetary amount of the purchase, and a transaction tracking number; composing at least one purchase summary based on the aggregation of one or more transaction entries; and sending the at least one purchase summary to at least one of a carrier owner and a third party.

6. The method of claim 1, further comprising one of requesting at least one of a second card payment validation from the ground transaction processor and obtaining a cash payment to complete the purchase on the payment transaction system when a payment card denial that terminates the purchase is received from the ground transaction processor.

7. The method of claim 1, further comprising at least one of obtaining a signature from a payment card holder and printing a receipt when payment approval is received.

8. A system for conducting a near real-time payment card processing on a vehicle, comprising:
one or more interface devices configured to accept automatic propagation of itinerary information, present commodities information from a software database, transmit payment card information for one or more transaction, and receive and display one of an approval and a denial of card payment for each transaction;
a ground transaction processor configured to provide one of an approval and a denial of card payment in near real time based on each transmitted payment card information; and
a network structure configured to at least transport data between the one or more interface devices and the ground transaction processor.

9. The system of claim 8, wherein the network structure configured to transport data includes at least one of a vehicle file server, one or more vehicle data service units, one or more ground data service units, and a ground server.

10. The system of claim 8, where in the network structure configured to transport data includes a data transport service configured to regulate the transportation of data between the one or more interface devices and at least one of the one or more ground portals and the ground transaction processor.

11. The system of claim 8, wherein each of the one or more interface devices is one of a hand-held interface device and a cabin-mounted interface device.

12. The system of claim 8, wherein each of the one or more interface devices is further configured to provide printed receipts and receive electronic signatures.

13. The system of claim 8, wherein each of the one or more interface devices are in wireless communication with the vehicle file server, and the vehicle file server is configured to automatically enter itinerary information into each of the one or more interface devices.

14. The system of claim 13, wherein the itinerary information includes at least one of a flight number, a flight origin, and a flight destination.

15. The system of claim 9, wherein each of one or more interface devices are further configured to provide transaction information for each transaction to the vehicle file server, wherein the transaction information includes at least one of the one or more commodities purchased, a quantity of each commodity purchased, a monetary amount of purchase, and a transaction tracking number, and wherein the vehicle file server is further configured to generate at least one purchase summary based on the aggregated transaction information.

16. The system of claim 15, wherein the ground server is configured to provide the at least one purchase summary generated by the vehicle file server to at least one carrier owner.

17. The system of claim 15, further comprising one or more ground portals configured to provide the at least one purchase summary generated by the cabin file server to one of at least one third party and at least one carrier owner, wherein the network structure is further configured transport data between the one or more interface devices and the one or more ground portals.

18. The system of claim 15, wherein each of the one or more interface devices are further configured to record the amount of cash payment for one or more transactions, and the monetary amount of purchase includes the amount of the cash payment.

19. A method for conducting cash transactions on a vehicle, comprising:
logging in at least one operator to conduct one or more transactions on a payment transaction system;
propagating at least one piece of itinerary information into each transaction by automatic entry;
selecting one or more commodities for purchase from a menu of commodities for each of the one or more transaction;
recording a cash transaction entry for each of the one or more transactions, wherein each cash transaction entry includes at least one of commodities purchased, a quantity of each commodity purchased, a monetary amount of the purchase, and a transaction tracking number; and
composing at least one purchase summary, wherein the purchase summary is based on an aggregation of the one or more cash transaction entries.

20. Method of claim 19, wherein propagating at least one piece of itinerary information into the payment transaction system by automatic entry includes propagating at least one of a flight number, a flight origin, and a flight destination.

21. Method of claim 19, further comprising sending the at least one purchase summary to at least one of a carrier owner and a third party. Client Disc. No. 05-1092A
